(19) United States
(12) Patent Application Publication
(10) Pub. No.: US 2017/0074399 A1
(43) Pub. Date: Mar. 16, 2017

(54) LIGHTWEIGHT PISTON PIN AND METHOD FOR MANUFACTURING THE LIGHTWEIGHT PISTON PIN

(71) Applicant: HYUNDAI MOTOR COMPANY, Seoul (KR)

(72) Inventor: Hak Soo KIM, Seoul (KR)

(21) Appl. No.: 14/954,758

(22) Filed: Nov. 30, 2015

(30) Foreign Application Priority Data
Sep. 14, 2015 (KR) 10-2015-0129422

(51) Int. Cl. F16J 1/16; B22F 1/00; B22F 3/00; B22F 3/10; C22C 38/00; B22F 5/00; C22C 38/24; C22C 38/22; C22C 38/04; C22C 38/02; F16J 1/01; B22F 3/24

(52) U.S. Cl. CPC F16J 1/16; F16J 1/01; B22F 1/0059; B22F 3/004; B22F 3/1021; B22F 3/1028; B22F 3/24; B22F 5/008; C22C 38/24; C22C 38/22; C22C 38/04; C22C 38/02; C22C 38/002; F05C 2201/0412; F05C 2201/0448; F05C 2201/0406; B22F 2003/248; B22F 2201/20; B22F 2301/35; B22F 2302/10; B22F 2304/10; B22F 2998/10

(57) ABSTRACT

A method for manufacturing a lightweight piston pin includes preparing a mixture of a base metal powder comprising chromium, carbon and iron, a TiC powder and a binder, metal powder injection molding (MIM) the mixture into a piston pin shape, degreasing the molded body to remove the binder from the mixture, sintering the binder-deprived, molded body, forming an intermediate layer composed of chromium carbide that surrounds the TiC powder in the sintered body, and transforming a matrix structure of the sintered body into a martensitic structure.

### CROSS REFERENCE TO RELATED APPLICATION

The present application claims the benefit of priority to Korean Patent Application No. 10-2015-0129422, filed Sep. 14, 2015 with the Korean Intellectual Property Office, the entire content of which is incorporated herein for all purposes by this reference.

### TECHNICAL FIELD

The present disclosure relates to a lightweight piston pin, and a method for manufacturing the lightweight piston pin. More particularly, the present disclosure relates to a lightweight piston pin that has improved elasticity, and a manufacturing method thereof.

### BACKGROUND

A reciprocating engine is an engine structured to use a piston to transmit a pressure generated in a cylinder to the crankshaft connected with the piston through a connecting rod, thereby providing a driving force. In most types, the linear reciprocating movement of the piston is converted to rotational motion via a connecting rod and a crankshaft. In this regard, the connecting rod has a large end that is rotatably connected to a crankpin of the crankshaft and a small end that is attached to the piston via a piston pin. Once generated in the cylinder of the reciprocating engine, the pressure is exerted to the piston and thus transmitted to rotate the crankshaft.

In reciprocating engines, a piston pin, which is typically a cylindrical rod, passes through the piston boss and the connecting rod and thus connects the piston and the connecting rod. Involved in the transmission of the movement of the piston to the connecting rod, the piston pin is likely to break during the transmission when its elasticity is poor and may be apt to cause a greater loss of the generated driving force when its weight is heavier. Therefore, a highly elastic, lightweight piston pin is ideal for improving durability and fuel efficiency.

Conventionally, piston pins are made of tough steel that has undergone heat treatment such as forging. Such piston pins suffer from the problem of high density and insufficient elasticity. To solve the problem, Metal powder Injection Molding (MIM) was developed, but the pistons manufactured by MIM, although low in density, exhibited lower strength and elasticity, compared to conventional pistons.

Accordingly, many attempts have been made to use TiC powder in addition to a base metal powder for MIM. For example, a material available in MIM is disclosed in Japanese conventional art.

In this patent, the tool steel comprises 1.4˜2.0 wt % of carbon, 1.0 wt % or less of silicon, 1.0 wt % or less of manganese, 11.0˜13.0 wt % of chromium, 0.3˜2.3 wt % of titanium, 0.75 wt % or less of a combination of nickel and copper, 5.0 wt % or less of a reinforcing element selected from among molybdenum, vanadium, tungsten and a combination thereof.

The tool steel has the advantage of titanium carbide restraining grains from coarsening; expanding a sintering temperature range to increase productivity; and reducing an amount of titanium to decrease the production cost.

However, the art is directed toward a tool steel, and does not mention an increase in elasticity, which is useful for piston pins that are exposed to extreme vibration.

### SUMMARY OF THE DISCLOSURE

Accordingly, the present disclosure has been made keeping in mind the above problems occurring in the prior art, and an object of the present disclosure is to provide a lightweight piston pin that exhibits a low density and high elasticity property, and a method for manufacturing the same.

In order to accomplish the above object, the present disclosure provides a method for manufacturing a lightweight piston pin, comprising: preparing a mixture of a base metal powder comprising chromium, carbon and iron, a TiC powder and a binder; metal powder injection molding (MIM) the mixture into a piston pin shape; degreasing the molded body to remove the binder from the mixture; sintering the binder-deprived, molded body; forming an intermediate layer composed of chromium carbide that surrounds the TiC powder in the sintered body; and transforming a matrix structure of the sintered body into a martensitic structure.

In one embodiment, the intermediate layer-forming step is carried out by maintaining the sintered mixture of the sintering step at 1000˜1050° C. for 2˜4 hrs to deposit chromium carbide around TiC powder and then furnace cooling the sintered mixture. In another embodiment, the preparing step is carried out by mixing the base metal powder having a particle size of 1˜10 μm, the TiC powder having a particle size of 0.5˜5 μm, and a liquid binder.

In another embodiment, the preparing step is carried out by combining a mixture containing a weight ratio of 78˜82% : 18˜22% of the base metal powder : the TiC powder with the binder, the base metal powder comprising, by weight: C: 1.4˜1.6%, Si: 0.4% or less (0% exclusive), Mn: 0.6% or less (0% exclusive), P: 0.03% or less (0% exclusive), S: 0.03% or less (0% exclusive), Cr: 11˜13%, Mo: 0.8˜1.2%, V: 0.2˜0.5%, a balance amount of Fe to form 100%, and inevitable impurities.

In another embodiment, the molding step is carried out at 180˜205° C.

In another embodiment, the degreasing step is carried out at 120° C. for 7 hrs or longer.

In another embodiment, the sintering step is carried out at 1200˜1250° C. for 20 hrs or longer in a vacuum.

In another embodiment, the martensitic transformation step is carried out by heating at 950˜1050° C., air cooling at 300° C. or less to construct a martensitic structure, and then tempering at 500˜600° C.

In accordance with another aspect, the present disclosure provides a lightweight piston pin, manufactured by metal powder injection molding (MIM) of a mixture of a base metal powder comprising chromium, carbon and iron, and a TiC powder, wherein the piston pin has a martensite structure in which the TiC powder surrounded with chromium carbide is dispersed.

In one embodiment, the base metal powder comprises, by weight: C: 1.4˜1.6%, Si: 0.4% or less (0% exclusive), Mn: 0.6% or less(0% exclusive), P: 0.03% or less (0% exclusive), S: 0.03% or less (0% exclusive), Cr: 11˜13%, Mo: 0.8˜1.2%, V: 0.2˜0.5%, a balance amount of Fe to form 100%, and inevitable impurities.

In another embodiment, the mixture is prepared by combining a mixture containing a weight ratio of 78˜82%: 18˜22% of the base metal powder:the TiC powder with a binder.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is an image of a matrix structure of a piston pin according to one embodiment of the present disclosure in which TiC surrounded with chromium carbide is dispersed in a martensitic matrix.

FIG. 2A shows an image of the steel matrix structures of a piston pin according to one embodiment of the present disclosure without reheating;

FIG. 2B shows an image of the steel matrix structures of a piston pin according to one embodiment of the present disclosure with reheating for 2 hours;

FIG. 2C shows an image of the steel matrix structures of a piston pin according to one embodiment of the present disclosure with reheating for 4 hours;

FIG. 3A shows an image of steel matrix structures where the particle sizes of base metal powder and TiC powder are within the reference degree, in which TiC is uniformly distributed upon sintering;

FIG. 3B shows images of steel matrix structures where the particle sizes of base metal powder and TiC powder exceed the reference degree, in which TiC is aggregated locally upon sintering;

FIG. 4A shows an image of a compression test result of a piston pin manufactured in Comparative Example 1;

FIG. 4B shows an image of a compression test result of a piston pin manufactured in Example 1;

FIG. 4C shows an image of a compression test result of a piston pin manufactured in Example 2;

FIG. 4D shows an image of a compression test result of a piston pin manufactured in Comparative Example 2;

FIG. 5A shows a stress-strain curve of a piston pin manufactured in Comparative Example 1 upon compression testing;

FIG. 5B shows a stress-strain curve of a piston pin manufactured in Example 1 upon compression testing;

FIG. 5C shows a stress-strain curve of a piston pin manufactured in Example 2 upon compression testing; and

FIG. 5D shows a stress-strain curve of a piston pin manufactured in Comparative Example 2 upon compression testing.

### DETAILED DESCRIPTION

The terminology used herein is for the purpose of describing particular embodiments only and is not intended to be limiting of example embodiments of the disclosure. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Below, a description will be given of the manufacture of a lightweight piston pin according to an embodiment of the present disclosure, in conjunction with the accompanying drawings. Unless specified otherwise, the term “%” means weight %.

In accordance with an aspect thereof, the present disclosure addresses a method for manufacturing a lightweight piston pin.

The lightweight piston of the present disclosure is prepared from a mixture of a base metal powder composed essentially of chromium, carbon and iron, and a TiC powder. The base metal powder must be able to form a martensite after being subjected to sintering and heat treatment processes. The composition of the base metal powder preferably follows that of SKD11 steel, but is not limited thereto.

SKD11 steel has the following composition: C: 1.4˜1.6%, Si: 0.4% or less (0% exclusive), Mn: 0.6% or less (0% exclusive), P: 0.03% or less (0% exclusive), S: 0.03% or less (0% exclusive), Cr: 11˜13%, Mo: 0.8˜1.2%, V: 0.2˜0.5%, Fe: balance, and inevitable impurities. SKD11 steel is poor in processability, but exhibits excellent wear resistance. Herein, MIM is introduced so as to overcome such low processability and to enable processing of the steel.

Further, a binder may be used to provide moldability and flowability for the mixture. No particular limitations are imparted to the kind and amount of the binder. Selection may be made of the kind and amount of the binder in consideration of moldability and flowability. However, a liquid organic binder is preferred considering properties of metal powder.

As will be described in detail later, it is preferred that the base metal powder and the TiC powder range in size from 1 to 10 μm and from 0.5 to 5 μm, respectively, with a weight ratio of 18˜22%:78˜82% therebetween.

Once a binder is admixed to the mixture of the base metal powder and the TiC powder, the resulting admixture is subjected to metal powder injection molding (MIM) into a piston pin. In this context, the admixture is molded into a larger size than the real size of a piston of interest because the molded body will contract with the elimination of the binder.

Thereafter, steps of degreasing the molded mixture to remove the binder, sintering the binder-deprived mixture, forming an intermediate layer of chromium carbide surrounding the TiC powder, and transforming the matrix into a martenistic matrix are taken to complete a piston pin.

The molding step, the degreasing step, and the sintering step may be carried out according to the MIM process. Preferably, the molding step may be conducted at 180˜205° C., the degreasing step at 120° C. for 7 hours or longer, and the sintering step at 1200˜1250° C. for 20 hours or longer in a vacuum. The intermediate layer forming step may be taken immediately after the sintering step. When the sintering apparatus is different from the heat treatment apparatus, the sintered body is cooled to 600° C. or lower before the subsequent step.

Due to a high hardness, TiC may be prone to brittle fracture. Hence, TiC may be allowed to have high elasticity and appropriate toughness by being surrounded with martensite, which is of relatively high toughness. However, when directly distributed in a martensitic structure, TiC may secede from the martensitic structure. The TiC that secedes from the martensitic structure is likely to undergo brittle fracture. Thus, TiC is preferably surrounded with chromium carbide so that TiC can be stably fused into the martensite.

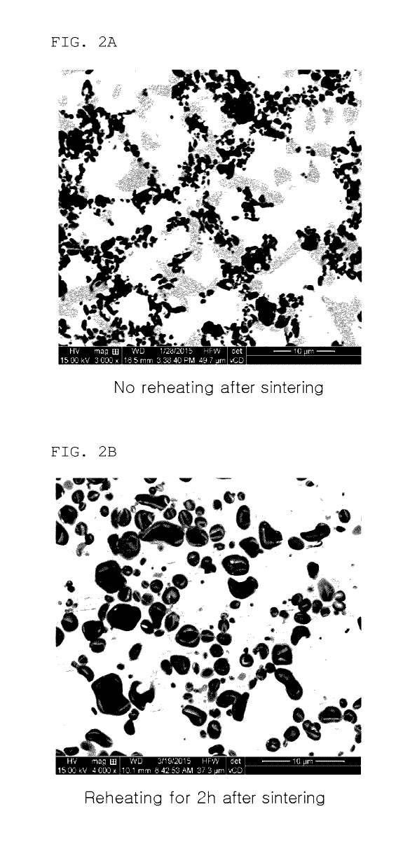

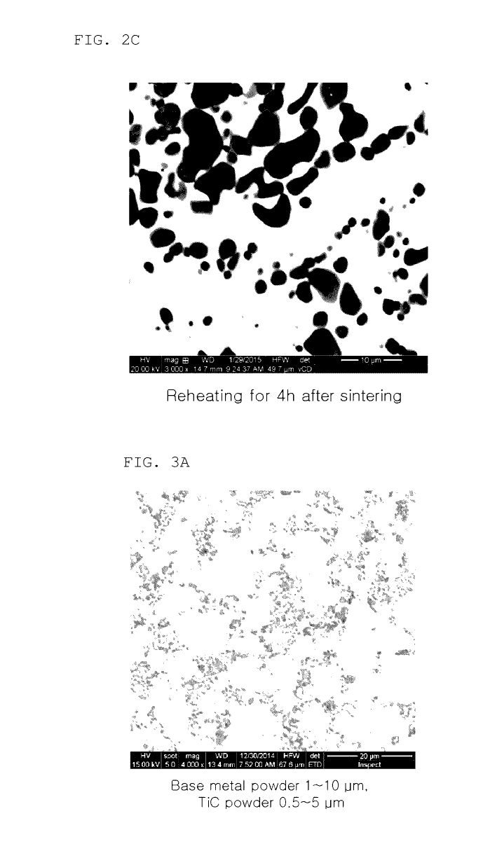

FIG. 2A is an image of a steel matrix structure that has been subjected to martensitic transformation immediately after completion of the sintering step without reheating. As shown, when TiC (black), chromium carbide (dark gray), and martensite (light gray) are separately formed, TiC secedes from the martensitic matrix.

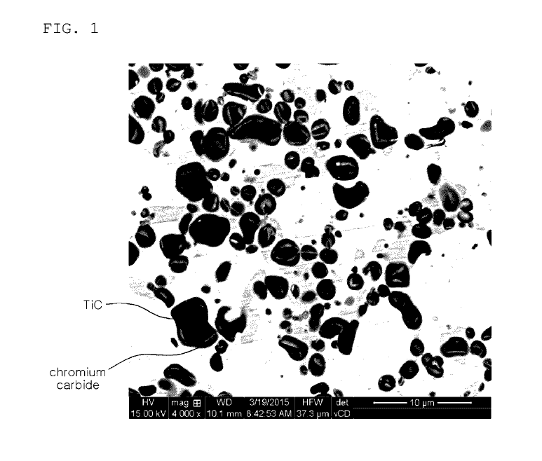

In contrast, FIGS. 1, 2B and 2C show a steel morphology in which TiC (black) is surrounded with chromium carbide (gray). Like this, when TiC is distributed in a martenistic matrix while being surrounded with a chromium carbide, the TiC improves the elasticity of the steel and is prevented from undergoing brittle fracture.

In order to construct this structure, a step of forming an intermediate layer by heating the sintered body at a predetermined temperature is taken after the sintering step.

The intermediate layer forming step is conducted by maintaining the sintered mixture at 1000˜1050° C. for 2˜4 hours to deposit chromium carbide around TiC powder, followed by furnace cooling to 600° C. or less to stabilize the phase. Furnace cooling, characterized by low cooling rates, allows for a stable phase without abrupt phase changes. In addition, rough machining may be employed after furnace cooling.

In the intermediate layer forming step, when the heating time is less than 2 hours, chromium carbide is insufficiently deposited and thus does not sufficiently surround TiC. On the other hand, a heating time exceeding 4 hours lengthens the working time and increases consumption energy as well as making TiC particles coarse.

Subsequent to the intermediate layer forming step, a martensitic transformation step is conducted in which the sintered mixture is heated at 950˜1050° C. and then air cooled to 300° C. or less to transform the matrix structure into a martensitic structure. Thereafter, tempering is conducted at 500˜600° C. to alleviate excessive rigidity and provide toughness.

In the following Examples, various piston pins were manufactured and measured for physical properties.

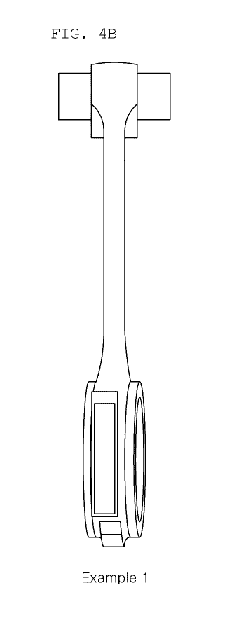

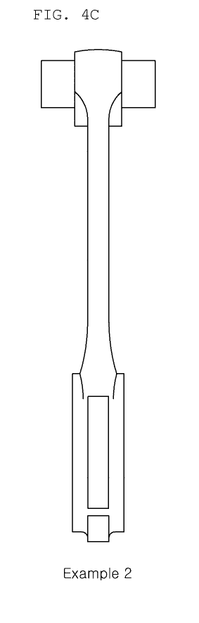

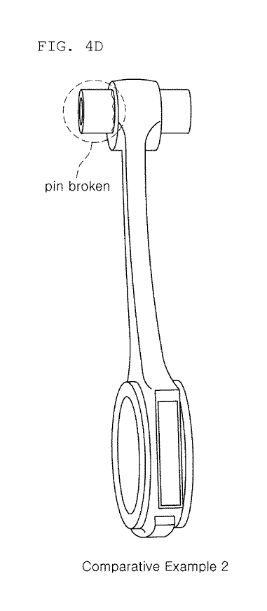

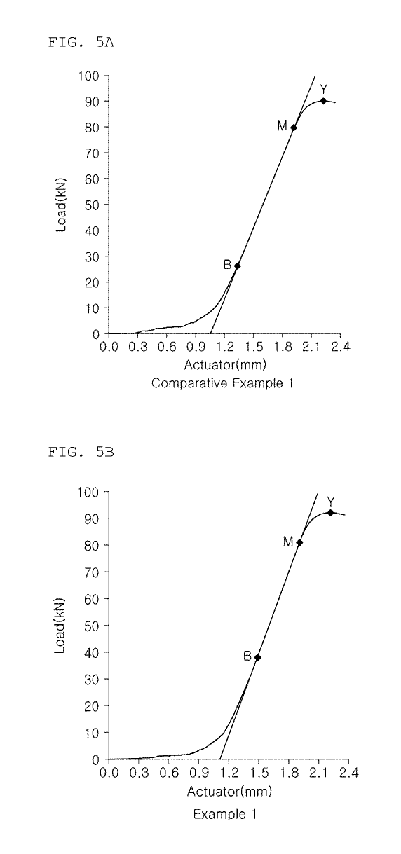

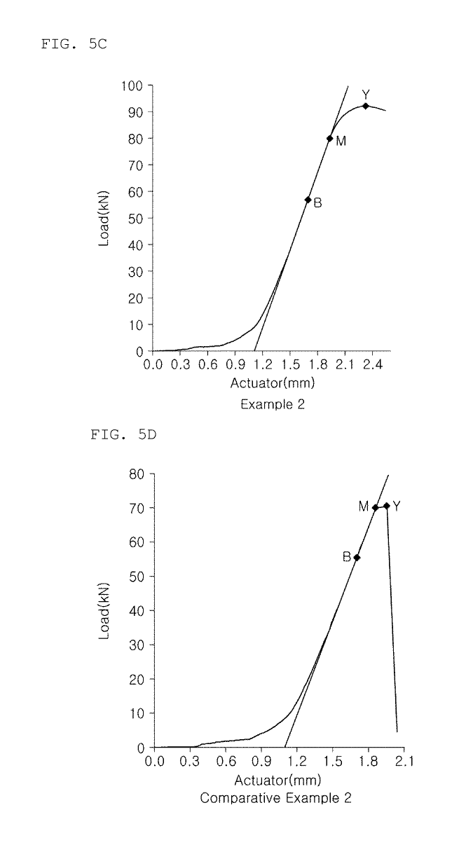

FIGS. 4A to 5D show Examples 1 and 2 and Comparative Examples 1 and 2.

Comparative Example 1 is a conventional steel mass product, made of carbonized SCM415, with a thickness of 4.25 mm (Φ18*9.5*42) and a weight of 56.9 g.

Comparative Example 2 is a steel product, made of Fe—25% TiC at a tempering temperature of 220° C., with a thickness of 2.5 mm, (Φ18*13*42) and a weight of 33.2 g.

Example 1 is a steel product, made of Fe—20% TiC at a tempering temperature of 220° C., with a thickness of 4.25 mm (Φ18*9.5*42) and a weight of 50.7 g.

Example 2 is a steel product, made of Fe—20% TiC at a tempering temperature of 550° C., with a thickness of 3.5 mm, (Φ18*11*42) and a weight of 46.3 g.

After being engaged to connecting rods, the piston pins were subjected to compression tests. As shown in FIGS. 4A to 4D, the piston pins of Comparative Example 1 and Examples 1 and 2 were observed to undergo neither distortion nor fracture until the connecting rods were strained (80 KN or higher). Therefore, the piston pins manufactured according to the present disclosure exhibit physical properties equivalent to those of the conventional mass product, but are lighter than the conventional mass product.

In contrast, the piston pin of Comparative Example 2, although far lighter because of a TiC content exceeding the upper limit defined in the present disclosure, underwent brittle fracture. As described above, brittle fracture is more likely to occur with a higher content of TiC, which is of high hardness.

FIGS. 5A to 5D show stress-strain curves of the piston pins of Examples 1 and 2 and Comparative Examples 1 and 2 upon a compression test. As can be seen in FIGS. 5A to 5D, the piston pins of Comparative Example 1 and Examples 1 and 2 started to strain at 82 KN, which was not attributed to the piston pins, but to the connecting rods. In other words, the connecting rods to which the piston pins were attached were distorted before the piston pins broke. The piston pin of Comparative Example 2 started to strain at 70 KN and finally fractured.

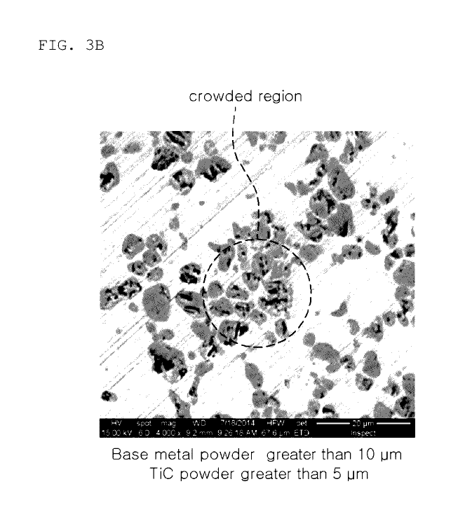

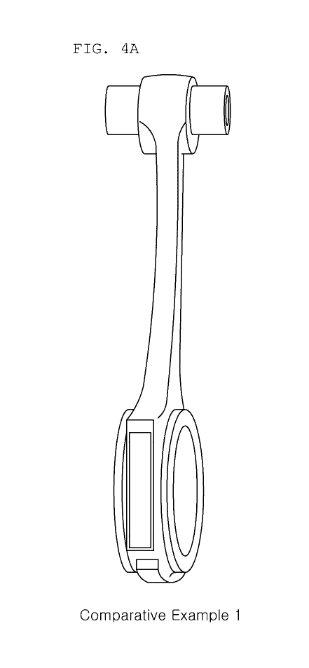

When TiC is used in an amount of 18% based on 100% of the mixture of the base metal powder and TiC powder, the piston pin has a high density, with negligible weight reduction effects that likely do not bring about an improvement in fuel efficiency. At a TiC content greater than 22%, the TiC powder amount is too great to be uniformly distributed within the matrix. When TiC is not uniformly distributed, but aggregates locally, the piston pin is likely to undergo brittle fracture, and shows poor processability. Hence, the mixture of the base metal powder and TiC powder preferably has a TiC content of 18˜22%. In addition, when particle sizes of the base metal powder and TiC powder are larger than predetermined criteria, TiC is not uniformly distributed, but aggregates. The aggregation of TiC is shown in FIG. 3B.

In FIG. 3A, TiC is uniformly distributed in the martensite matrix when the base metal powder and the TiC powder range in particle size from 1 to 10 μm and from 0.5 to 5 μm, respectively.

On the other hand, when the base metal powder and the TiC powder have particle sizes larger than 10 μm and 5 μm, respectively, TiC may crowd locally as shown in FIG. 3B. The aggregation of TiC causes an increase in brittleness and a decrease in processability. However, smaller particle sizes require a higher quantity of working time and energy. Hence, the base metal powder and the TiC powder preferably have particle sizes of 1˜10 μm and 0.5˜5 μm, respectively.

Consequently, the TiC particles in the metal structure of the piston pin exhibit most preferred properties at a poisson's ratio of 0.24˜0.26. At a poisson's ratio of less than 0.24, the TiC particles have a lengthy rod form and increased toughness. A poisson's ratio of greater than 0.26 causes the aggregation of TiC, thus increasing the brittleness of the piston pin.

Another aspect of the present disclosure addresses a lightweight piston pin, manufactured by metal powder injection molding (MIM) of a mixture of a base metal powder comprising chromium, carbon and iron, and a TiC powder, wherein the piston pin has a martensite structure in which the TiC powder surrounded with chromium carbide is dispersed.

Individual components of the piston pin are as described above.

As described hitherto, the lightweight piston pin and method for preparing the lightweight piston pin in accordance with the present disclosure exhibits the following effects:

First, the piston pin has a low density and is light, thus contributing to an increase in fuel efficiency.

Next, the piston pin has an increased longevity because of its improved elasticity.

Finally, the piston pin exhibits properties equivalent to those of conventional piston pins even when it is smaller in volume.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A method for manufacturing a lightweight piston pin, comprising:
preparing a mixture of a base metal powder comprising chromium, carbon and iron, a TiC powder and a binder;
metal powder injection molding (MIM) the mixture into a piston pin shape;
degreasing the molded body to remove the binder from the mixture;
sintering the binder-deprived, molded body;
forming an intermediate layer composed of chromium carbide that surrounds the TiC powder in the sintered body; and
transforming a matrix structure of the sintered body into a martensitic structure.

2. The method of claim 1, wherein the intermediate layer-forming step is carried out by maintaining the sintered mixture of the sintering step at 1000˜1050° C. for 2˜4 hours to deposit chromium carbide around TiC powder, and then furnace cooling the sintered mixture.

3. The method of claim 1, wherein the preparing step is carried out by mixing the base metal powder having a particle size of 1˜10 μm, the TiC powder having a particle size of 0.5˜5 μm, and a liquid binder.

4. The method of claim 3, wherein the preparing step is carried out by combining a mixture containing a weight ratio of 78˜82% : 18˜22% of the base metal powder : the TiC powder with the binder, the base metal powder comprising, by weight: C: 1.4˜1.6%, Si: 0.4% or less (0% exclusive), Mn: 0.6% or Less (0% exclusive), P: 0.03% or less (0% exclusive), S: 0.03% or less (0% exclusive), Cr: 11˜13%, Mo: 0.8˜1.2%, V: 0.2˜0.5%, a balance amount of Fe to form 100%, and inevitable impurities.

5. The method of claim 1, wherein the molding step is carried out at 180˜205° C.

6. The method of claim 1, wherein the degreasing step is carried out at 120° C. for 7 hours or longer.

7. The method of claim 1, wherein the sintering step is carried out at 1200˜1250° C. for 20 hours or longer in a vacuum.

8. The method of claim 1, wherein the martensitic transformation step is carried out by heating at 950˜1050° C., air cooling at 300° C. or less to construct a martensitic structure, and then tempering at 500˜600° C.

9. A lightweight piston pin, manufactured by metal powder injection molding (MIM) of a mixture of a base metal powder comprising chromium, carbon and iron, and a TiC powder, wherein the piston pin has a martensite structure in which the TiC powder surrounded with chromium carbide is dispersed.

10. The lightweight piston pin of claim 9, wherein the base metal powder comprises, by weight: C: 1.4˜1.6%, Si: 0.4% or less (0% exclusive), Mn: 0.6% or less (0% exclusive), P: 0.03% or less (0% exclusive), S: 0.03% or less (0% exclusive), Cr: 11˜13%, Mo: 0.8˜1.2%, V: 0.2˜0.5%, a balance amount of Fe to form 100%, and inevitable impurities.

11. The lightweight piston pin of claim 9, wherein the mixture is prepared by combining a mixture containing a weight ratio of 78˜82%:18˜22% of the base metal powder:the TiC powder with a binder.
